(19) United States
(12) Patent Application Publication
(10) Pub. No.: US 2009/0067596 A1
(43) Pub. Date: Mar. 12, 2009

(54) MULTIMEDIA PLAYING DEVICE FOR INSTANT INQUIRY

(75) Inventors: He-Teng HSU, Hsinchu (TW); Shi-Ming CHEN, Hsinchu (TW)

Correspondence Address: Muncy, Geissler, Olds & Lowe, PLLC, P.O. BOX 1364, FAIRFAX, VA, 22038-1364, US

(73) Assignee: SOUNDWIN NETWORK INC.

(21) Appl. No.: 12/194,961

(22) Filed: Aug. 20, 2008

(30) Foreign Application Priority Data
Sep. 11, 2007 (TW) 096215230

(51) Int. Cl. H04B 1/00

(52) U.S. Cl. 379/110.01

(57) ABSTRACT

A multimedia playing device for instant inquiry is provided. The multimedia playing device includes a display, an image display unit, a calling module, and an auto-dialing module. The image display unit is adapted for displaying a multimedia program, such as an advertisement, on the display. The calling module is adapted for providing a calling service. When a user is attracted by information of a certain advertisement, he can instantly press a dialing key or simply pick up a handset of a telephone, and then the auto-dialing module correspondingly automatically dials a phone number presented in the multimedia program via the calling module and tries to build a call connection. In such a way, the user can instantly inquire related information about the advertisement, without any need for writing down the contact information presented in the advertisement, or dialing the phone number himself.

### BACKGROUND OF THE INVENTION

1. Field of the Invention

The present invention relates generally to a multimedia playing device, and in particular, to a multimedia playing device adapted for instant inquiry.

2. The Prior Arts

Current advertising systems including print media, e.g., newspapers and magazines, and advertising media, e.g., televisions and networks spread advertisements generally by broadcasting. However, such advertising systems are not suitable for transmitting information toward preselected consumer groups in a specific time range and at a predetermined site for effective advertisement.

For the purpose of effectively playing an advertisement, one may like to play a specific advertisement for a specific consumer group according to a predetermined marketing policy toward this consumer group. For example, supposing an advertisement is specifically prepared for businessmen, then the advertisement is better to be played at where businessmen often gather, e.g., hotels; or if the advertisement is specifically prepared for young people, then the advertisement is better to be played at where the young people often gather, such as cinemas, or fast food chain restaurants. In such a way, prospective consumers can be divided into different groups and respectively addressed by specifically prepared advertisements. A method of doing so has been disclosed in one conventional prior art, which is about an electronic apparatus having advertisement playing function.

As discussed above, ordinary advertising media are often not so effective. Further, advertisements played by those ordinary advertising media are typically single directional, so that even though a prospective consumer watches the advertisement and is interested in it, there is no facility provided with the advertising system for him to contact the advertiser. The only thing he can do is to write the contact information of the advertiser, e.g., phone number or email address, and contact the advertiser by dialing the phone number or sending an email later. Unfortunately, this is inconvenient for consumers to adopt such ways to contact advertisers. In many cases, the consumers may dislike or even forget to contact the advertisers only because of the inconvenience. As to the advertisers, they are often unsure about the effect of the advertisement they distributed because they have no idea about from where the consumers know the advertised merchandise.

As a solution addressing to the aforementioned difficulty, another conventional prior art, which is about an interactive TV set having a phone and a method thereof, proposed to integrate a television and a phone, which allows a consumer, when viewing TV, to dial a contact phone number displayed in the advertisement. In this case, he can use a phone included in the interactive TV set, and does not need to find an additional. However, contact information displayed in advertisements often lasts only a short time, e.g., several seconds, and usually passes over before one finds out a pen and a paper for writing it down. Even though the contact information can be written down in hurry, the interactive TV set is still inconvenient for the consumers to instantly inquire the advertisers.

### SUMMARY OF THE INVENTION

A primary objective of the present invention is to provide a multimedia playing device for instant inquiry, which is adapted for automatically dialing a phone number presented in an advertisement played by the multimedia playing device, so as to allow a user to instantly inquire related information about the advertisement without any need for writing down the phone number corresponding to the advertisement, or dialing the phone number by himself.

According to the foregoing objective, the present invention provides a multimedia playing device for instant inquiry. The multimedia playing device includes a display, an image display unit, a calling module, and an auto-dialing module. The image display unit is adapted for displaying a multimedia program, such as an advertisement, on the display. The calling module is adapted for providing a calling service. When a user is attracted by information of a certain advertisement, he can instantly press a dialing key or simply pick up a handset of a telephone, and then the auto-dialing module correspondingly automatically dials a phone number presented in the multimedia program via the calling module and tries to build a call connection. In such a way, the user can instantly inquire related information about the advertisement, without any need for writing down the contact information presented in the advertisement, or dialing the phone number himself.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram illustrating a multimedia playing device for instant inquiry according to a first embodiment of the present invention;

FIG. 2 is a block diagram illustrating a multimedia playing device for instant inquiry according to a second embodiment of the present invention;

FIG. 3 is a block diagram illustrating a multimedia playing device for instant inquiry according to a third embodiment of the present invention; and

FIG. 4 is a block diagram illustrating a multimedia playing device for instant inquiry according to a fourth embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

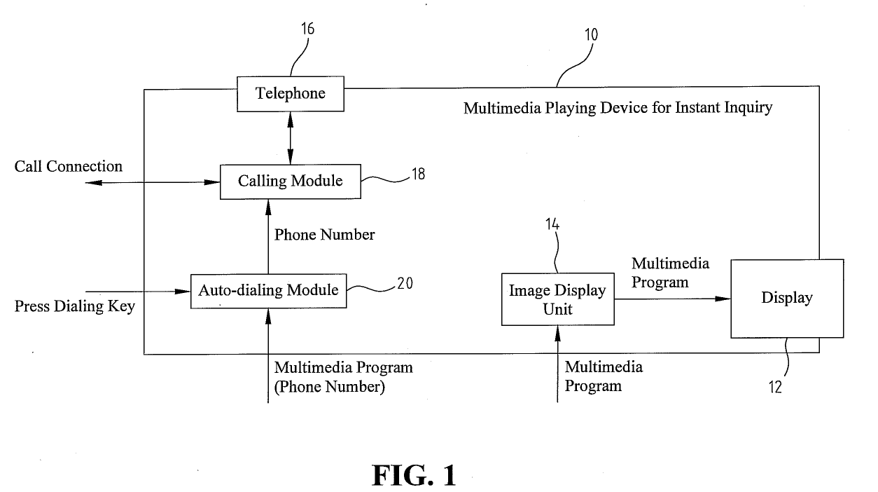

FIGS. 1-4 are block diagrams illustrating embodiments of a multimedia playing device for instant inquiry according to the present invention, in which same numbers representing same subject matters as discussed in the embodiments. Referring to FIG. 1, a multimedia playing device 10 in accordance with a first embodiment of the present invention includes a display 12, an image display unit 14, a telephone 16, a calling module 18, and an auto-dialing module 20. The image display unit 14 is adapted for displaying a multimedia program, such as an advertisement, on the display 12. The calling module 18 is adapted for providing phone call service. According to an aspect of the embodiment, the calling module 18 for example can be either a network calling module or an analog calling module.

As shown in FIG. 1, in operation of the multimedia playing device 10, a multimedia program, e.g., an advertisement, is played on the display 12. If a user is attracted by the advertisement, he can press a dialing key (not shown) or pick up a handset of the telephone 16, and then the auto-dialing module 20 is enabled to automatically dial a phone number corresponding to the multimedia program and try to build a call connection. In such a way, the user is capable of instantly inquiring related information about the advertisement. This is very convenient for the user since he does not need to write down the contact information of the advertisement, or dial the phone number himself. According to an aspect of the embodiment, the phone number dialed by the calling module 18 can be included in a certain portion of the multimedia program, or built in a memory medium (not shown) of the multimedia playing device 10 of the present invention.

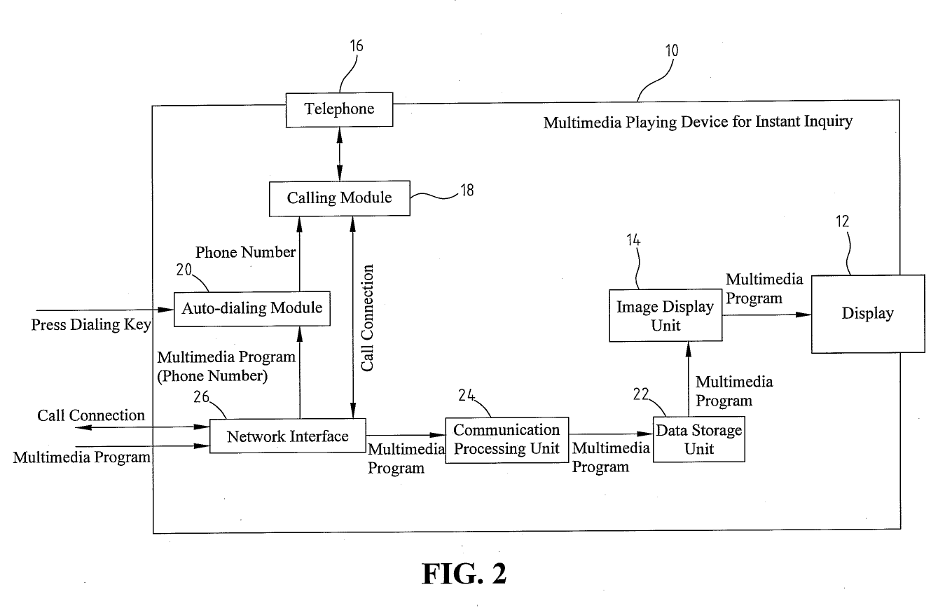

FIG. 2 is a block diagram illustrating a multimedia playing device for instant inquiry according to a second embodiment of the present invention. Comparing with the embodiment of FIG. 1, the multimedia playing device 10 of FIG. 2 further includes a data storage unit 22, a communication processing unit 24, and a network interface 26. The employment of the data storage unit 22 allows the multimedia playing device 10 to repeatedly play the multimedia program. The data storage unit 22 is adapted for storing an incoming multimedia program therein, so as to allow the image display unit 14 to retrieve the multimedia program unlimitedly therefrom, and therefore the multimedia program can be displayed on the display 12.

According to an aspect of the embodiment, the multimedia program can be stored into the data storage unit 22 via a cable network, a wireless network, or a portable storage device, i.e., a USB drive. As shown in FIG. 2, the communication processing unit 24 is adapted to receive the multimedia program via the network interface 26, and store the multimedia program into the data storage unit 22. Further, according to an aspect of the embodiment, the calling module 18 is a network calling module, and the process of trying to build a call connection is processed via the network interface 26.

According to the foregoing embodiments, the multimedia program for example can be of JPEG, MJPEG, MPEG, or H.264 compression formats. As such, prior to being provided to the image display unit 14, the multimedia program which was compressed needs to be decoded by an image processing unit (not shown). When the multimedia program further includes voice signals, a voice processing unit is required for decoding the voice signals.

The multimedia program can include videos or images. Furthermore, the multimedia program according to another aspect of the embodiment may also be interactive, for example including an interactive program guide. In details, the display 12 of the multimedia playing device 10 is preferably a touch control display. The multimedia program being displayed on the touch control display 12 can provide a main menu advertising classification frame, which allows the user to select a desired advertisement to view according to the main menu advertising classification frame. For example, suppose the main menu frame includes a restaurant information option, a movie information option, and an opera/drama information option. Upon a selection of any of the foregoing information by touching the corresponding option, the user can view further detail information about the option he selected. Therefore, whenever he needs to book a table, a seat or a ticket, he can pick up the handset of the telephone or press the dialing key, and then the auto-dialing module 20 is enabled to automatically dial the phone number corresponding to the multimedia program via the calling module 18 to call the advertiser. According to the current embodiment, comparing with the conventional single directional multimedia playing device, the multimedia playing device 10 of the present invention is adapted to provide bi-directional service to the user, by which the user and the multimedia playing device 10 can be interactive via the touch control menu.

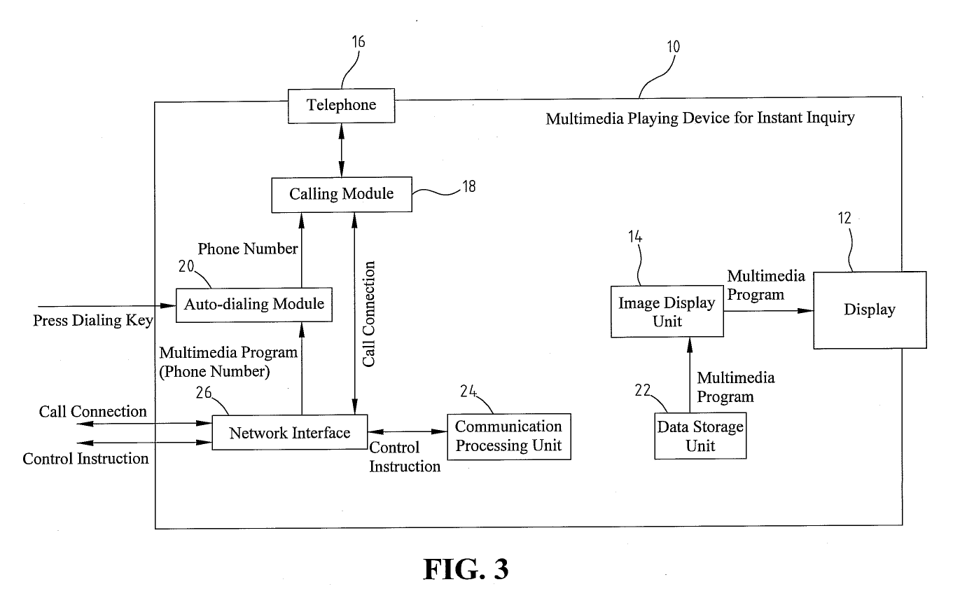

For the purpose of managing and evaluating the values of advertisements, the multimedia playing device 10 adapted for instant inquiry can be widely distributed to collecting desired data for analysis. As shown in FIG. 3, there is shown a block diagram illustrating a multimedia playing device for instant inquiry according to a third embodiment of the present invention. According to the embodiment as shown in FIG. 3, the multimedia playing device 10 can further interact with a far end server, such as an advertising management platform, a terminal management platform, or a statistics platform via the communication processing unit 24. Briefly, before receiving a control instruction via the network interface 26, the communication processing unit 24 informs related software for processing and thereafter provides data that the control instruction requires to transmit back.

The advertisement management platform generally includes functions as below:
1. Uploading content of the advertisement, in which a web interface is provided for allowing the user to transmit an advertisement file to the server;
2. Editing content of the advertisement, in which useful information including locations and time ranges of the advertisement playing is provided to the user for editing the advertisement file; and
3. Searching of content of the advertisement, in which the user is allowed to conveniently search the advertisement file.

The terminal management platform generally includes functions as below:
1. Transmitting content of the advertisement to bidirectional multimedia advertising terminals, in which the advertising file is transmitted to specific bidirectional multimedia advertising terminals to play in specific time range according to advertising file using information;
2. Managing statuses of the multimedia advertising terminals, in which operation statues of the multimedia advertising terminals are collected at predetermined times and prepared for a statistics form; and
3. Fee management for managing advertising fees of clients, including estimation of advertising fee and advertisement balance.

The statistics platform collects the operation statues of the multimedia advertising terminals and prepares a statistics form thereof, which is provided to the advertiser for reference to further modifying the advertisement.

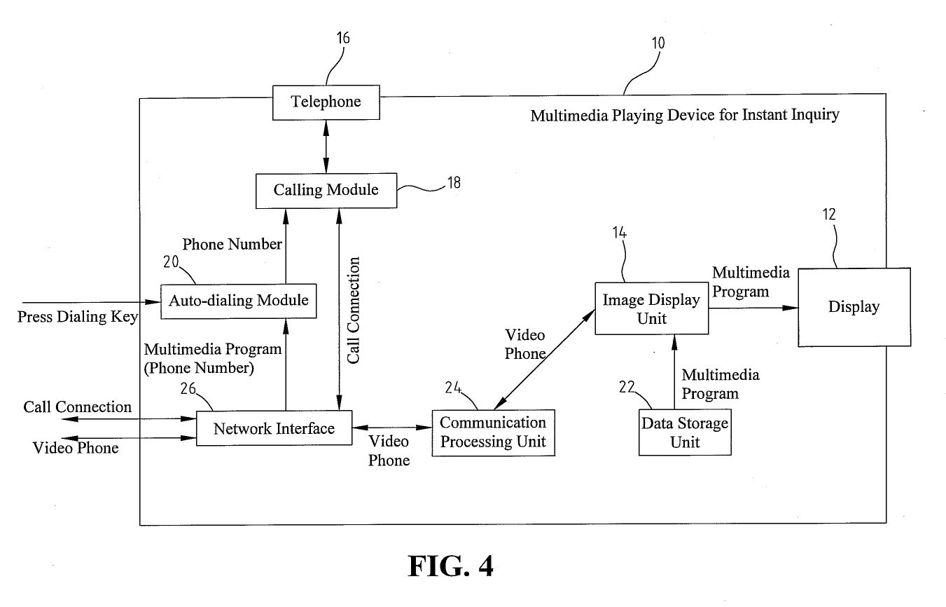

In summary, the multimedia playing device 10 for instant inquiry according to the present invention not only provides a telephone 16 for the user to contact the advertiser, but also provides the probability for the advertiser to provide related images for the user or conduct a video phone communication with the user. As shown in FIG. 4, there is shown a block diagram illustrating a multimedia playing device for instant inquiry according to a fourth embodiment of the present invention. Referring to FIG. 4, when the user is in connection with the advertiser, the advertisement trustee may transmit the images or instant video to the display 12 for the user for viewing.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A multimedia playing device for instant inquiry, comprising:
a display;
an image display unit, adapted for displaying a multimedia program on the display;
a calling module, adapted for providing a calling service; and
an auto-dialing module, adapted for dialing a phone number corresponding to the multimedia program via the calling module, and for trying to build a call connection.

2. The multimedia playing device according to claim 1, further comprises a telephone, wherein when a handset of the telephone is picked up, the auto-dialing module is enabled to automatically dial the phone number corresponding to the multimedia program via the calling module.

3. The multimedia playing device according to claim 1, wherein when a dialing key is pressed, the auto-dialing module is enabled to automatically dial the phone number corresponding to the multimedia program via the calling module.

4. The multimedia playing device according to claim 1, wherein the calling module is one of a network calling module and an analog calling module.

5. The multimedia playing device according to claim 1, further comprising:
a data storage unit, for storing the multimedia program, wherein the image display unit is adapted to retrieve the multimedia program from the image storage unit, and display the multimedia program on the display.

6. The multimedia playing device according to claim 5, further comprising:
a network interface; and
a communication processing unit, adapted for receiving the multimedia program via the network interface, and storing the multimedia program into the data storage unit.

7. The multimedia playing device according to claim 1, further comprising:
a network interface; and
a communication processing unit, adapted for receiving a control instruction via the network interface, and providing data that the control instruction requires to transmit back.

8. The multimedia playing device according to claim 6, wherein the network interface is a wireless network interface, or a cable network interface.

9. The multimedia playing device according to claim 7, wherein the network interface is a wireless network interface, or a cable network interface.

10. The multimedia playing device according to claim 1, wherein the phone number corresponding to the multimedia program is included in the multimedia program.

11. The multimedia playing device according to claim 1, wherein the display is a touch control display, and the multimedia program can be displayed on the display with an interactive menu.
